(19) United States
(12) Patent Application Publication
(10) Pub. No.: US 2002/0029681 A1
(43) Pub. Date: Mar. 14, 2002

(54) Guitar chord finder

(76) Inventor: Thomas James Manning, Mahwah, NJ (US)

Correspondence Address: THOMAS J. MANNING, 116 ARMOUR RD., MAHWAH, NJ, 07430, US

(21) Appl. No.: 09/848,710

(22) Filed: May 3, 2001

Related U.S. Application Data
(60) Provisional application No. 60/202,683, filed on May 8, 2000.

(51) Int. Cl. G09B 15/02

(52) U.S. Cl. 84/477 R

(57) ABSTRACT

The Guitar Chord Finder is a digital device that will aid the beginning guitar player in learning the various chords needed to play the guitar successfully. This devise can be used in both learning and testing mode for the beginning guitar player. The design of the devise resembles the exact shape of the first four frets on a regular guitar, plus an additional space at the bottom of about two inches which will contain various switches to operate the unit. What is unique about this devise is that it is digital and compact in its design.

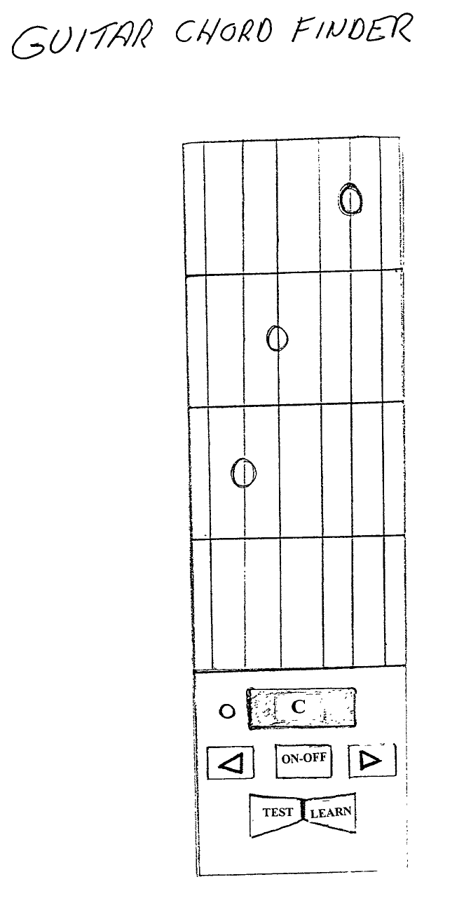

While in the digital learning mode, the user will be able to select one of the basic guitar chords and the corresponding proper finger location will light up on the fretboard for that given chord. The user will then place his/her fingers on the indicated locations and a green light will appear once the fingers are placed properly. In the digital testing mode, the use will be able to select one of the basic guitar chords and will then have to place his/hers fingers on the proper locations on the fretboard, without the digital lights indicating where the spots are. If the fingers are placed in the proper locations, then the green light will signal a successful attempt.

The compact styling enables one to use the devise without requiring a lot of space. The devise can be held in one hand or two, as there will be a slide rule on the back for adjusting positions.

The Guitar Chord Finder is a device that will aid the beginning guitar student in learning the various chords needed to play the guitar successfully. It will be a two function device:

1. the student will be able to learn where the fingers go on the fretboard in order to play the various chords. 2. the student will be able to test themselves to see if they are placing the fingers correctly on the fretboard for each respective chord.

The Guitar Chord Finder will be the exact shape of the first four sections of a regular fretboard, plus an additional space at the bottom of about 2 inches which will contain the various switches to operate the unit. This will make the device very easy to hold in one hand. The devise will also have the exact guitar string arrangement (six in all) across the four sections of fretboard. The back of the device will contain a slide out section at the bottom, similar to how a slide ruler works. This slide out portion will enable the user to hold on to the devise with two hands if need be.

Here's how the Guitar Chord Finder will work:

In the two inch section of the device below the fretboard will be the following:

1. an on/off switch

2. a digital screen which will show the various type of “chords”

3. two arrow buttons on either side of the on/off switch by which the player can advance or backup to a particular chord

4. a test/learn button which will put the device in the respective mode, depending on how the user want it to work

5. a small light that will light up green when the proper task is performed.

In the learning mode, here's how the device will work:

The user will press the on/off switch to start the device. They will then press the button to put the device in the “learn” mode. The digital screen will then light up and the “A” chord will appear in the screen. The various finger points for the “A” chord will then light up on the fretboard. The user will then place the appropriate fingers on the appropriate positions on the fretboard to play the “A” chord. Once the fingers are placed correctly, the green light will come on to indicate that it was done successfully.

The user can then press the arrow button and move up to the next chord. The same procedure will apply. The corresponding finger points will light up on the fretboard to place that specific chord. Again, with proper finger placement, the green light will indicate a successful position. The arrow button will allow the user to advance or backup to whatever particular chord they want to learn.

In the test mode, here's how the device will work:

The user will press the on/off switch to start the device. They will then press the button to put the device in the “test” mode. The digital screen will then light up and the “A” chord will appear in the screen. The user will then place their fingers on the fretboard that they associate with the “A” chord. If it is the right placement, the green light will light up indicating that the “A” chord was played correctly. Then the user can use the arrow button to test their knowledge on other chords.

What is claimed is:

1. A device that will aid the beginning guitar student in learning the various chords needed to play the guitar successfully.

2. A devise of claim 1 with two distinct functions including:
a) the user's ability to learn where the fingers go on the fretboard in order to play the various chords
b) the user's ability to test themselves to see if they are placing the fingers correctly on the fretboard for each respective chord.

3. The devise of claim 1 will be the exact shape of the first four sections of a regular fretboard.

4. The devise of claim 1 will include a space at the bottom (2 inch approximate) which will contain the various switches to operate the unit.

5. The components of claim 4 comprises:
An on/off switch to power the unit
A digital screen to display the current chord in operation
Two (2) arrow buttons on either side of the power switch by which the user can advance or backup to a particular chord
A test/learn button which will put the device in the respective mode of operation
A small green light that will illuminate when the proper task is performed.

6. The devise of claim 1 will be configured to the exact specifications of a guitar fretboard.

7. The components of claim 6 comprises:
An arrangement of 6 faux guitar strings
Four (4) sections of fretboard
A slide out handle at the bottom, to enable the user to hold the devise with two hands.

8. The functionality of claim 4 in the learning mode whereby the digital screen will light up with the chord name and the various finger points for that respective chord illuminate on the fretboard.

9. The effect of claim 8 is for the user to place the appropriate fingers on the appropriate positions on the fretboard to play the respective chord. Once the fingers are placed correctly, the green light will come on to indicate that it was done successfully.

10. The functionality of claim 4 in the test mode whereby the digital screen will light up with the chord name only.

11. The effect of claim 10 is for the user to test their knowledge of the chords by placing their fingers on the fretboard associated to the chord name that appears. If the fingers are placed properly, the green light will illuminate.
